(19) United States
(12) Patent Application Publication
(10) Pub. No.: US 2003/0095366 A1
(43) Pub. Date: May 22, 2003

(54) Fault-tolerant power-supply current-sharing apparatus and methods

(76) Inventor: John Pellegrino, Westford, MA (US)

Correspondence Address: TESTA, HURWITZ & THIBEAULT, LLP, HIGH STREET TOWER, 125 HIGH STREET, BOSTON, MA, 02110, US

(21) Appl. No.: 09/961,130

(22) Filed: Sep. 21, 2001

(51) Int. Cl. H02H 3/08

(52) U.S. Cl. 361/93.1

(57) ABSTRACT

A fault-tolerant current-sharing system and process for eliminating the disadvantages of a single-point-of failure of the prior art current-sharing applications where multiple power supplies provide a proportional amount of current to a common load. According to one aspect of the invention, the system provides redundancies of the current-sharing signal and isolating signal flow within the current-sharing circuitry. The system comprises a power-supply terminal connected to the current-share terminal of a power supply, and a first and second output terminal transmitting a first and second current-share output signal, respectively, to similar devices associated with other power supplies. Each device includes a first and second isolator, each electrically connected between the first and second output terminal, respectively, and the power supply terminal. Each device also includes a first and second input terminal electrically connected to the power-supply terminal, each terminal respectively receiving a first and second current-share input signal.

### FIELD OF THE INVENTION

The invention relates generally to electrical power supplies and more specifically to electrical power supply systems that employ current sharing.

### BACKGROUND OF THE INVENTION

In many applications, a single power source is used to supply power to an electrical load. In certain applications, it may be advantageous to replace the single power source with multiple power sources supplying power to the electrical load. For example, systems having an electrical load drawing relatively high current require a relatively large power supply to source the necessary current. High-current power supplies typically include larger components, such as transformers and capacitors and use larger gauge electrical conductors within the power supply. These larger components add cost and complexity to system designs.

In multi-power supply applications, the voltage output terminals of each of the multiple power supplies may be connected together in a parallel circuit configuration to apply voltage to the same load. In such a configuration, often referred to as a current-sharing configuration, each power supply provides a fractional contribution of current that is summed together with the current contributions of the other interconnected power supplies.

In current-sharing applications, some means is typically employed to ensure that each power supply is, in fact, contributing its respective contribution of current and that the power supplied to the load is regulated within the design limits. Typically, a feedback circuit is employed at each power supply to control the supplied power. Regulating power supplied to a load is particularly important in high-reliability systems where the mean-time between failures of system components depends to some extent on the current stress experienced by each of the components-tight control of the operating current can assist in maintaining the desired reliability.

Such a current-sharing approach offers advantages in system reliability. Where each power supply has sufficient spare capacity, the system of power supplies may continue to provide any required load current when one or more of the power supplies fails. In some current-sharing power supply applications, a common current-share signal is connected to each power supply module in the system. The current-share signal is typically generated by a master power supply and indicates the required current to be supplied by each power supply. The current-share signal is used by each power supply module in a local current feedback circuit. A power supply feedback circuit typically senses the output current and adjusts the output voltage of the power supply responsive to the current-share signal, forcing the output current supplied by that power supply to match the load current corresponding to the common current-share signal. Where one of the power supplies fails, the load continues to draw substantially the same current under the same applied voltage (as is the case for parallel connected power supplies). Kirchoff's current law requires that each of the remaining, unfaulted contributing power supplies increases its individual contribution by an amount such that the sum of all currents (the load current) remains the same. The feedback circuit of each power supply, sensing the increased current output, operates to ensure that the relative output current of each of the power supplies maintains the designed proportionality. This approach is particularly well suited to fault-tolerant systems.

Unfortunately, a fault in the current-sharing circuitry just described would likely result in the parallel output voltage becoming unregulated. For example, if the current-share signal at one of the power supply modules were shorted to ground potential, the current-share signal at each of the other power supplies would also appear shorted to ground potential. Without the ability of feedback control of the current, the current supplied by the individual power supplies would likely vary, resulting in the voltage supplied to the load operating outside a design regulation value. Similar results may occur for an open-circuit fault, or a fault to the supply voltage level occurring within the current-sharing circuitry of any of the power supplies.

### SUMMARY OF THE INVENTION

The present invention relates to a fault-tolerant current-sharing system and process that eliminates the disadvantages of the single-point-of failure that exists in prior art current-sharing power supplies. The present invention provides redundancies of the current-sharing signal, thus improving the ability of the system to withstand a fault within the current-share circuitry. The present invention also isolates signal flow within the current-sharing circuitry, and offers a monitoring capability to support system determination of the “health” of each of the individual power supplies.

According to one aspect of the invention, a fault-tolerant current sensing device allows a number of power supplies, each equipped with a current-share terminal and supplying current to a common electrical load, to tolerate a failure at the current-share terminal of at least one of the number of power supplies. In one embodiment, each device includes a power-supply terminal connected to the current-share terminal of the power supply, and a first and second output terminal transmitting a first and second current-share output signal, respectively. Each device also includes a first and second isolator, each electrically connected between the first and second output terminal, respectively, and the power supply terminal. Each device also includes a first and second input terminal electrically connected to the power-supply terminal, each terminal respectively receiving a first and second current-share input signal.

In one embodiment, the device includes a fault detector electrically connected to the power-supply terminal. In one embodiment, the fault detector includes a monitor receiving a power-supply current-share output signal and a comparator determining a difference between the received power-supply current-share output signal and a predetermined signal threshold.

In another embodiment, the isolator includes a current-sourcing amplifier. In one embodiment, the current-sourcing amplifier is a single-stage transistor amplifier, such as an emitter-follower amplifier. In another embodiment, the isolator includes a first and second switch, each electrically connected between the first and second output terminal, respectively, and the power-supply terminal. In another embodiment, each switch operates responsive to receiving a signal from the fault detector. In yet another embodiment, the switch includes an electronic switch such as a transistor switch (e.g., a field-effect-transistor (FET) switch).

In another aspect of the invention, a current-sharing power supply system includes a number of power supplies, each power supply having an output load terminal connected in parallel and supplying an output current to a load, having a current-share terminal receiving a power-supply current-share input signal, being capable of controlling its respective output current responsive to the power-supply current-share input signal, and transmitting a power-supply current-share output signal, to tolerate a failure at the current-share terminal of at least one of the number of power supplies. In one embodiment, a process for tolerating a failure affecting the power-supply current-share output signal includes the steps of receiving a first and second current-share input signal, transmitting a power-supply current-share input signal to a power supply, receiving a power-supply current-share output signal from the power supply, generating from the power-supply current-share output signal a first and second current-share output signal, and transmitting the first and second current-share output signal.

In some embodiments, the process includes the step of electrically isolating the power-supply current-share input signal from the first and second current-share output signal responsive to detecting a fault. In one embodiment, the power-supply current-share input signal is isolated from the first and second current-share output signal using an electrical amplifier. In another embodiment, the process includes the step of detecting a fault with the power-supply current-share output signal by monitoring the power-supply current-share output signal and comparing the monitored signal to a predetermined signal threshold.

In one embodiment, the step of isolating the first and second current-share output signals from the power-supply current-share output signal includes controlling a switch responsive to detecting the fault; whereas, in another embodiment, the step of isolating the output signals includes the step of driving the power-supply current-share output signal to a fault signal level (e.g., electrical ground).

In another aspect of the invention, a fault-tolerant current-sharing power supply system including a number of power supplies to tolerate a failure at the current-share terminal of at least one of the power supplies where each power supply has a load terminal in electrical communication with a load providing a proportional output current to the load and a current-share terminal receiving a power-supply current-share input signal, where each power supply is capable of modifying its output current responsive to the received power-supply current-share input signal, a number of fault-tolerant current-sharing devices, each having a power-supply terminal electrically connected to the current-share terminal of a respective one of the number of power supplies, a first and a second input terminal, each electrically connected to the power supply terminal, a first and a second output terminal electrically connected to a respective one of the first and second input terminal of another of the number of current-sharing devices, and a first and a second isolator, each electrically connected to the power-supply terminal and a respective one of the first and second output terminal.

Yet another aspect of the invention relates to a device for fault-tolerant current-sharing in a power supply system including a number of power supplies, each power supply (i) having an output load terminal connected in parallel and supplying an output current to a load, (ii) having a current-share terminal receiving a power-supply current-share input signal, (iii) being capable of controlling its respective output current responsive to the power-supply current-share input signal, and (iv) transmitting a power-supply current-share output signal. In some embodiments, the device includes means for receiving a first and second current-share input signal, a means for transmitting a power-supply current-share input signal to a power supply, a means for receiving a power-supply current-share output signal from the power supply, means for generating, from the power-supply current-share output signal, a first and second current-share output signal, and means for transmitting a first and second current-share output signal.

In one embodiment, the device includes means for isolating the first and second current-share output signal from the respective current-share input signal. In another embodiment, the isolation means includes a switching means for electrically isolating the first and second current-share output signal, respectively, from the power-supply current-share output signal. In yet another embodiment, the device further includes a means for detecting a fault in the power-supply current-share output signal.

In yet another aspect of the invention, a fault-tolerant current-sensing device allowing a power supply system that includes a number of current-sensing power supplies to tolerate a failure at the current-share terminal includes a power-supply terminal electrically connected to a current-share terminal of a power supply, a first field-effect transistor switch electrically connected to the power supply terminal, a first amplifier having an input electrically connected to the field-effect transistor switch and an output, where the first amplifier transmits a first current-share output signal, a first output terminal electrically connected to the first amplifier output, a first input terminal electrically connected to the power-supply terminal and receiving a first current-share input signal, a second field-effect transistor switch electrically connected to the power supply terminal, a second amplifier having an input electrically connected to the field-effect transistor switch and an output, the second amplifier transmitting a second current-share output signal, a second output terminal electrically connected to the second amplifier output, a second input terminal electrically connected to the power-supply terminal and receiving a second current share input signal; and a fault detector in communication with the power-supply terminal, detecting a faulty power-supply current-share output signal.

### BRIEF DESCRIPTION OF THE DRAWINGS

The invention is pointed out with particularity in the appended claims. The advantages of the invention may be better understood by referring to the following description taken in conjunction with the accompanying drawing in which:

FIG. 1 is a block diagram depicting an embodiment of the fault-tolerant current-sensing device;

FIG. 2 is a block diagram depicting an embodiment of the isolator shown in the fault-tolerant current-sharing device of FIG. 1;

FIG. 3 is a block diagram depicting an embodiment of the fault detector shown in the fault-tolerant current-sharing device of FIG. 1;

FIG. 4 is a flow chart of an embodiment of the steps of the embodiment of the fault-tolerant current-sensing device shown in FIG. 1; and

FIG. 5 is a block diagram of an embodiment of a system incorporating the fault-tolerant current-sensing device shown in FIG. 1.

### DETAILED DESCRIPTION OF THE INVENTION

The present invention relates to a device that enables a power supply configured to supply electrical current to a load in a current-sharing configuration with one or more similarly configured power supplies to experience a fault within the current-sense circuitry of the power supply and related electrical interconnections without compromising the current-sharing arrangement of the remaining power supplies.

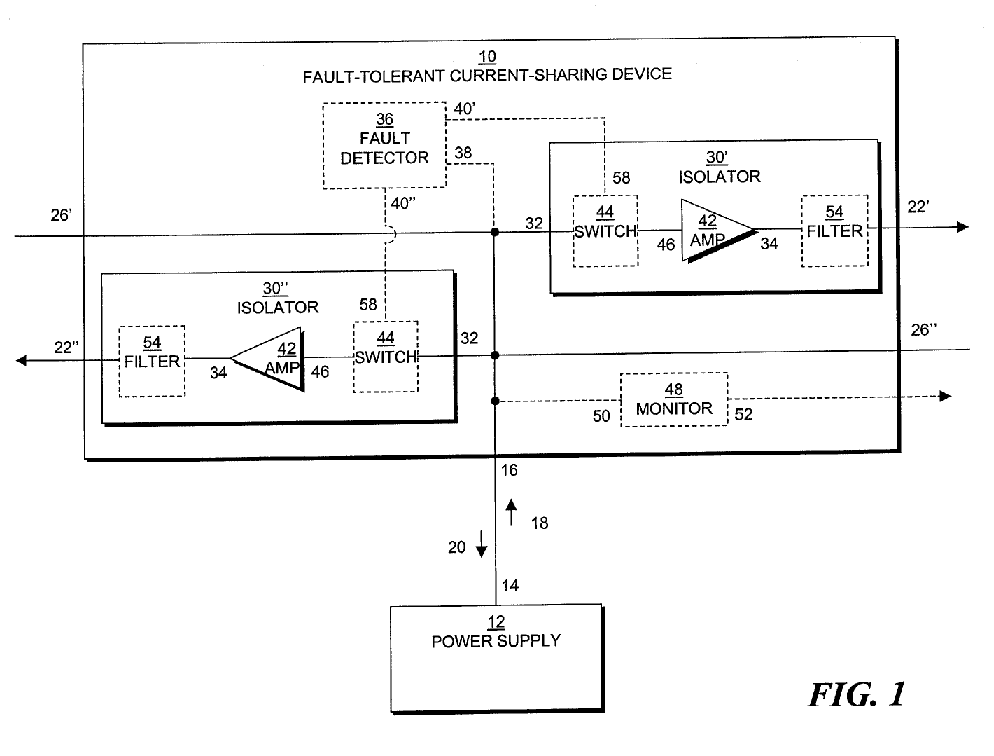

Referring to FIG. 1, one embodiment of a fault-tolerant current-sharing device (device) 10 is shown. The device 10 enables a power supply 12 equipped with a current-share terminal 14 to tolerate a fault relating to the current-sensing circuitry of the power supply 12, and/or the associated electrical interconnections and circuitry external to the power supply 12. For interconnection with the power supply 12, the device 10 includes a power supply terminal 16. The device 10 receives at the power supply terminal 16 a power-supply current-share output signal 18 transmitted from the power supply 12. The device 10 transmits a power-supply current-share input signal 20 through the power supply terminal 16 to the power supply 12. For interconnections with other devices 10, the device 10 includes a first output terminal 22′ and a second output terminal 22″ (generally 22), through which, the device 10 transmits a first current-share output signal and a second current-share output signal, respectively. The device 10 also includes a first input terminal 26′ and a second input terminal 26″ (generally 26), through which, the device 10 receives a first current-share input signal and a second current-share input signal, respectively.

The device 10 shown in FIG. 1 also includes a first isolator 30′ and second isolator 30″ (generally 30). The isolators 30 function to isolate the monitored signal 18 from interactions caused by sources external to the device 10, such as other similar devices 10 paired with other power supplies 12. Each of the isolators 30 includes a respective input terminal 32 and a respective output terminal 34. The input terminal 32 of each of the isolators 30 is in electrical communication with the power supply terminal 16 through which each of the isolators 30 receives the power-supply current-share output signal 18. The output terminal 34 of each of the isolators 30 is in electrical communication with a respective output terminal 22 of the device 10.

The device 10 optionally includes a fault detector 36 (shown in phantom) in electrical communication with the power supply terminal 16. In one embodiment, the fault detector 36 includes at least three terminals: one input terminal 38 and two output terminals 40′, 40″. In this embodiment, the fault detector 36 is in electrical communication with each of the isolators 30 through respective fault-detector output terminals 40′, 40″. The fault detector 36 receives, at its input terminal 38, signals available at the power-supply terminal 16. The fault detector 36 monitors those signals for the presence of a fault condition and transmits a fault signal to each of the isolators 30 upon detection of a fault.

In some embodiments, such as applications using power supplies 12 equipped with a single-conductor current-share capability, the power-supply terminal 16 accommodates a single conductor, where the conductor may be an electrical conductor, such as copper, or aluminum wire, or an optical conductor, such as an optical fiber. The single conductor carries both the power-supply current-share output signal 18 and the power-supply current-share input signal 20. In other embodiments, the power-supply terminal 16 includes sub-terminals where each sub-terminal is capable of accommodating one or more conductors. For example, the power-supply terminal 16 may contain two sub-terminals: one sub-terminal accommodating the power-supply current-share output signal 18; the other sub-terminal accommodating the power-supply current share input signal 20. Each of the power-supply signals 18, 20 may, in turn, consist of a single conductor, or multiple conductors (e.g., a single wire for a single-ended signal, or a pair of wires, such as a signal line and a return line for differential, or balanced signals). Each of the power-supply signals 18, 20 may also include modulated signals, such as a frequency modulated, or pulse-code modulated signals, or digitally-coded signals requiring multiple lines, or communicated serially over a single line. Likewise, each of the device input terminals 22 and/or output terminals 26 may also consist of a single terminal communicating with a single conductor, or several sub-terminals, each sub-terminal communicating with a single conductor for embodiments having multi-conductor signals.

In one embodiment, the terminals 16, 22, 26 include screw-type terminal blocks. In another embodiment, the terminals 16, 22, 26 include plugs and/or jacks (such as ⅛-inch standard “tip-plugs” or “tip-jacks, ” or ¼-inch “phone plugs” or “phone-jacks”). In yet other embodiments, the terminals 16, 22, 26 may include electrical and/or optical connectors.

In some embodiments, the device 10 may be configured individually as a single, standalone module, where one module is interconnected to each of the power supplies 12. In another embodiment, the device 10 may be incorporated within the power supply 12. In yet other embodiments, multiple devices 10 may be grouped together and configured as one module capable of interconnecting to multiple power supplies 12, each device 10 connected to a respective power supply 12.

Physically, each device 10 may be packaged within a chassis, or a housing, such as a rack-mountable housing; or as a circuit element, such as an electrical printed circuit board. For a more compact embodiment, the device 10 may be packaged as a component, such as a hybrid-circuit module, or an application-specific integrated circuit (ASIC).

In more detail, the isolator 30 typically includes an amplifier 42 and, optionally, a switch 44 (shown in phantom). The amplifier 42 is configured with an input 46 and an output 34. The amplifier input 46 is in electrical communication with the power supply terminal 16 from which it receives the power-supply current-share output signal 18. The output 34 of each amplifiers 42 is in electrical communication with the respective output port 22 of the device 10 through which the amplifier 42 transmits the current-share output signal.

In some embodiments, the device 10 includes a monitor 48 for monitoring the power-supply current-share output signal 18. The monitor 48 may provide an indication of the operational status of the power-supply current-share output signal 18. Generally, the monitor 48 includes an input 50 for receiving the power-supply current-share output signal 18 and an output 52 for transmitting the monitored status.

In some embodiments, the monitor 48 includes a comparator for comparing the monitored signal to a predetermined threshold. For example, the comparator output may be used to drive a user indicator, such as a front-panel mounted LED indicating to the user that the monitored current share signal level is operating normally (e.g., a “signal good” indication). In other embodiments, the monitor 48 includes an analog-to-digital converter for converting the monitored signal level to a digital number. For example, the output of the analog-to-digital converter may be used to drive a user indicator, such as a front-panel display. In yet other embodiments incorporating an analog-to-digital converter, the monitor 48 may include microprocessor-based hardware, such as a monitoring integrated circuit for substantially continuously monitoring the analog, power-supply signals and transmitting the digital data representation of the monitored signals to other system components.

In some embodiments, the isolator 30 includes a filter 54 between the amplifier 34 output and output port 22 that further isolates the current-share signal from electrical noise sources external to the device 10. In general, the filter 54 may include series-connected circuitry filtering out common-mode noise and/or shunt-connected circuitry filtering out differential-mode noise. The filter's circuitry may include combinations of passive components, such as diodes, capacitors, inductors, and the like; active components, such as other transistor and operational amplifiers; or combinations of active and passive components.

In some embodiments the isolator 30 may include a switch 44. For example, the switch 44 may be in electrical communication between the amplifier input and the power supply terminal 16. The switch 44 is configured with at least three terminals: one terminal in electrical communication with the amplifier input 56 a second terminal 32 in electrical communication with the power supply terminal 16 and a third terminal 58 accepting a control input signal to control the operation of the switch 44. When the switch 44 opens, signals from the power supply terminal 16 do not flow to the amplifier 42 for transmission. The switch 44 may be locally controlled, or optionally, remotely controlled. In one embodiment, the third terminal 58 is in electrical communication with the output terminal 40 of the fault detector 36. The switch 44 receives, through the third terminal 58, actuation signals from the fault detector 36.

Generally, the amplifier 42 isolates signals at its input 46 from the effects of signals at its output 34. In one embodiment, the amplifier 42 provides as output the current-share output signal, while protecting input signals received through the power supply terminal 16 from any adverse effects (such as short-circuit faults) experienced by the current-share output signal. In some embodiments, the amplifier 42 functions primarily as a signal buffer rather than a gain device. For example, where the current-share output signal of one amplifier 42 is provided as an input to another device 10 and a failure at the other device 10 short-circuits the signal at the amplifier's output 34 to electrical ground, the amplifier 42 will protect signals at the power supply terminal 16 from the direct effects of the short-circuit.

In some embodiments, the amplifier 42 is a current-sourcing amplifier. The amplifier 42 may also be a unity-gain amplifier providing a current-share output signal that is a representation of the power-supply current-share output signal 18. In other embodiments, the amplifier 42 may provide some signal conditioning such as providing a value of gain to offset losses, such as signal and interconnection losses. In some embodiments, the amplifier 42 is an operational amplifier. In other embodiments, the amplifier 42 may be a single-stage amplifier.

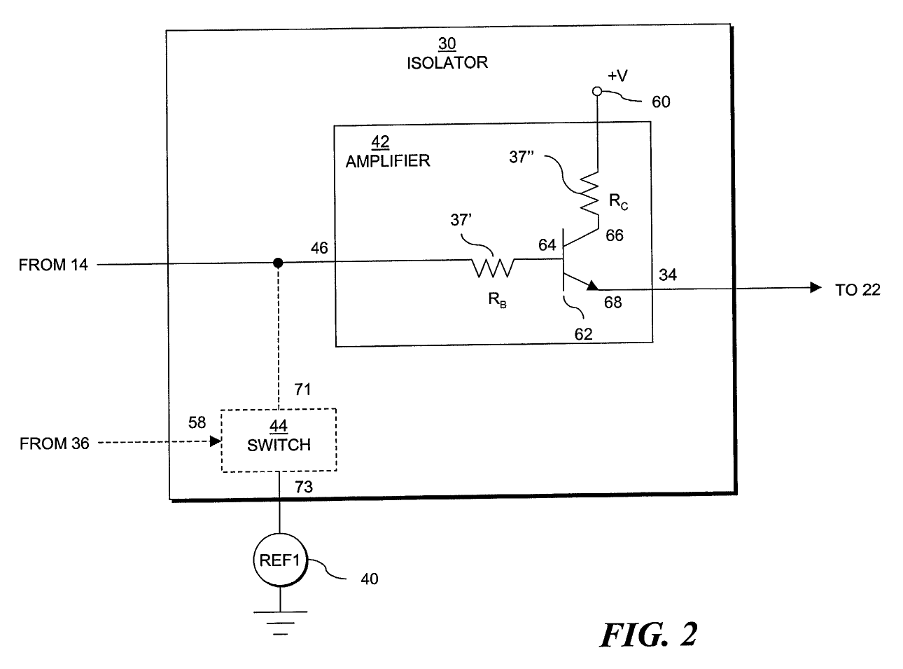

Referring now to FIG. 2, one embodiment of the isolator 30 is shown configured with a single stage amplifier 42 including a common-collector, or emitter-follower amplifier. The single-stage amplifier 42 may include a single-transistor circuit, such as a suitably-biased NPN transistor 62. Biasing resistors R_{B} 37′ and R_{C} 37″ (generally 37) in combination with a biasing voltage (+V) 60 have resistance and voltage values chosen, respectively, for operation of transistor 62 in the forward-active region. The transistor 62 includes three terminals: a base terminal 64, a collector terminal 66, and an emitter terminal 68. Input signals at the collector terminal 66, such as those that may result from a fault (e.g., a short-to-ground of the current-share output signal 24) will not have a direct impact on signals input at the transistor base terminal 62. Single-stage amplifier designs offer the advantages of being simple to implement, with few components, thus improving the overall device reliability by improving the reliability of the isolator 30. In some embodiments, other components may be included with the amplifier 42, such as additional biasing resistors 37, or filtering components (not shown), such as capacitors and inductors.

The switch 44 may be connected to the amplifier 42 in a shunt configuration as shown in which the switch 44 includes a first terminal 71 in communication with the amplifier input 46, a second terminal 73 in communication with a signal source (REF1) 40 and a third terminal 58 in communication with the fault detector 36. The amplifier input 46, in turn, is in communication with the transistor base terminal 64 through the biasing resistor R_{B} 37′. The switch 44 operates to alternately connect the amplifier input 46 to a predetermined signal value, shown as REF1 40. For example, when the switch is closed, the amplifier input 46 is connected to REF1 40. In one embodiment, REF1 40 may be 0 volts, or electrical ground. In other embodiments, REF1 40 may be a non-zero value. When the switch is opened (or suitably high impedance), the amplifier input is essentially unaffected by the presence of the switch 44. Generally, FIG. 1 illustrates an alternative embodiment of the switch 36 in a series configuration.

In some embodiments the switch 44 shown in FIG. 2 is a mechanical switch. In other embodiments, the switch 44 is an electronic switch, such as a transistor switch. The switch 44 may be remotely controlled without direct operator intervention. Where the switch 44 is remotely controlled, the control mechanism may be an electronic control mechanism, such as an electronic relay, an electronic control circuit, a mechanical device or even a chemical device, such as a squib-activated control mechanism.

The switch 44 may be a double-pole switch having two terminals, such as for embodiments where the current-share output signal consists of a single wire. For embodiments where the current-share output signal consists of more than one wire, the switch 42 may include an appropriate number of switches, such as a number of double-pole switches, one double-pole switch for each of the wires, with each of the double-pole switches having at least two terminals. In either regard, for a series-configured switch, a first switch terminal 32 is in electrical communication with the power supply terminal 16 and a second switch terminal 56 is in electrical communication with the amplifier input terminal 46. The amplifier output terminal 34 is in electrical communication with a respective one of the device output terminals 22. For a shunt-configured switch, the first switch terminal 32 may be in electrical communication with the amplifier input 46, while the second switch terminal 56 may be connected to electrical ground, or to some other potential value.

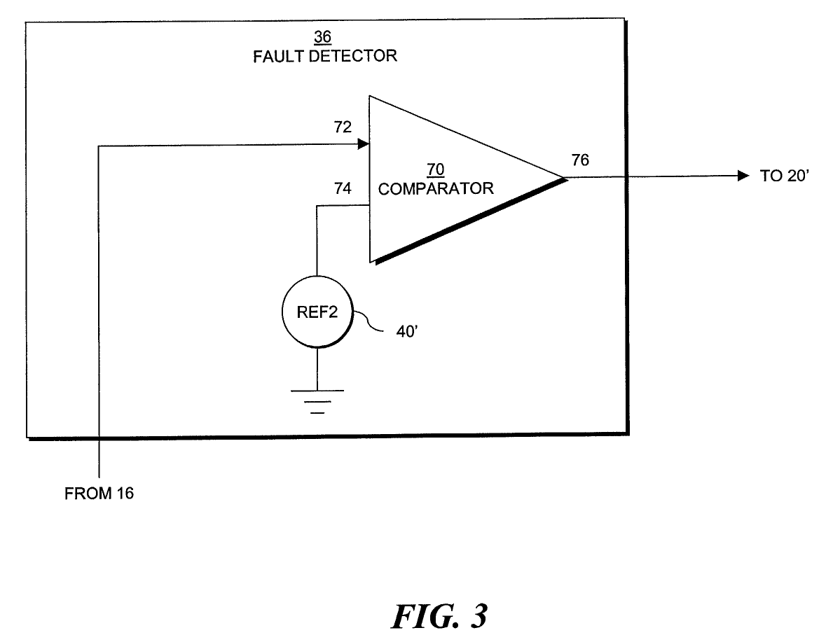

Referring now to FIG. 3, in one embodiment the fault detector 36 includes a comparator 70 and a signal reference 40′ (REF2). The comparator 70 is configured with at least two input terminals 72, 74 and one output terminal 76. One of the comparator input terminals 72 is in electrical communication with the power supply terminal 16. The other comparator input terminal 74 is in electrical communication with the REF2 40′. The comparator output terminal 76 is in electrical communication with the isolator 20.

Generally, the comparator 70 compares the input at one of the input terminals 72 to the REF2 40′ signal at the other input 74 provide an output signal that is dependent on the value of the signal difference. Typically, the comparator 70 provides a binary output indicating whether the signal difference between the signals at the input terminals is positive or negative. By having the signal level at one of the comparator inputs 74 equal to a reference potential (REF2), the signal level at the comparator output 76 indicates whether the signal level at the other input 72 is above or below the REF2 level. In one embodiment, the comparator 70 provides an output signal indicating that the received power-supply current-share output signal 18 is greater than the value, or signal level of REF2 40′. In some embodiments, the comparator output signal may be used to control the switch 36. For example, when the signal at the power supply terminal 16 is greater than REF2 40′, it may indicate a fault, such as a short to the supply voltage causing the signal to increase. The comparator 70 senses the signal has increased above the REF2 40′ level and transmits an output signal indicating the same. The comparator output may be used to operate the switch 44 shown in FIGS. 1 and 2 to isolate the power supply terminal 16 from the current-share signals external to the device 10.

In some embodiments, such as high-reliability systems, monitoring the status or health of operational signals is used as an indicator of the overall system reliability/fault-tolerant strategy. For example, in multiple, current-sharing power-supply embodiments, the individual current-share signals are substantially continuously monitored thus providing a valuable operational indicator. The monitored current-share signals may be used to perform “trending,” providing an indication of a suspect power supply 12 before any catastrophic failure actually occurs. The monitored current-share signals provide an indicator of trends in the power-supply signals from each of the multiple power supplies that can be used to predict the onset of a possible failure, and allow scheduled preventative maintenance of the system before the failure. If a power-supply failure does occur, the monitor 48 automatically provides information identifying which power supply failed so that the failed power supply can be replaced without shutting down the system. In one embodiment, the monitor 48 includes an Analog Devices integrated circuit part number ADM1024 ASIC. The ADM1024 provides five analog signal measurement channels, two fan-speed monitors, and a temperature sensor. The output data from the integrated circuit is digitized and transmitted as an output using an industrial standard I2C-compatable serial System Management Bus.

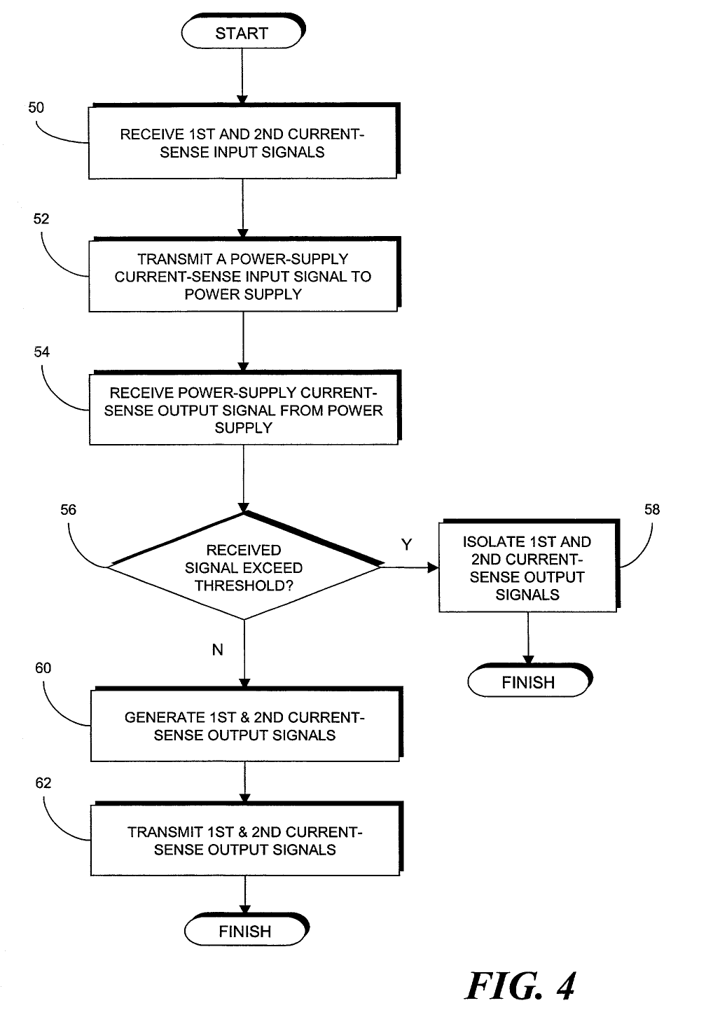

In operation, referring to FIG. 4, in one embodiment the device 10 operates to isolate the power-supply current-share input signal 20 from the current-share output signals because either of the current-share output signals may itself be provided by a source other than the power supply 12, such as under certain fault conditions. Also, for embodiments having the fault detector 36, the device 10 may be configured to isolate the current-share output signals from the power-supply current-share output signal 16 upon the detection of a fault. Thus, the device 10 operates to protect other devices from an erroneous current-share output signal that may result from a fault of the device 10 or its associated power supply 12.

In one embodiment the device 10 separately and substantially simultaneously receives the first current-share input signal at the first input terminal 26′ and the second current-share input signal at the second input terminal 26″ (step 50). Each of the current-share input signals may be transmitted by similar devices 10, respectively, connected to other power supplies 12, in which the power supplies 12 are configured as a coordinated set of power supplies 12 supplying current to an electrical load. The device 10 then transmits, through the power-supply terminal 16, the power-supply current-share input signal 20 to the power supply 12 (step 52). The power-supply current-share input signal 20 typically includes information from each of the first and second current-share input signals. In some embodiments, the power-supply current-share input signal 20 is a combination of each of the current-share input signals. For example, where the first and second current-share input signals 28 are primarily voltage signals, the power-supply current-share input signal 20 may generated by a parallel combination of the first and second input signals. The power supply 12 being equipped with the current-share capability receives at the current-share terminal 14 the power-supply current share input signal 20. The power supply 12 suitably configured with a current-sense feedback capability modifies its output current being supplied to the electrical load as required.

For example, in one embodiment the power supply 12 being configured with the current-sense feedback capability responds to the power-supply current-share input 20 signal by adjusting its output according to the greater of the two current-share input signals. That is, the power supply's current-sense capability operating according to positive-voltages adjusts the power supply load output according to the more-positive one of the current-share input signals and substantially ignores the less-positive signal. Thus, if the first current-share input signals were to experience a fault such as a voltage decrease or a short circuit to ground potential (i.e., 0 volts), the power supply's current-sharing capability would continue to operate normally according to the second current-share input signal. In such a configured system, one of the power supply/device combinations typically acts as a master by providing a current-share output signal that is slightly greater than the other current-share output signals from the other power supply/device combinations.

The power supply 12 transmits the power-supply current-share output signal 18 at the current-share terminal 14 while also receiving the power-supply current-share input signal 20. The power-supply current-share output signal 18 is generally representative of the level of electrical current being supplied by the power supply 12 to the electrical load and is ultimately supplied by the device 10 to other coordinating power supplies 12 in the form of the current-share output signals 24.

In further operation the device 10 receives the power-supply current-share output signal 18 from the power supply 12 (step 54). In one embodiment, the fault detector 36 of the device 10 monitors the received power-supply current-share output signal 18, determining whether the signal 18 exceeds a predetermined signal threshold (step 56). In one embodiment, the fault detector 36 configured with the comparator 70 compares the received power-supply current-share output signal 18 to the 18 is greater than the high-level threshold (e.g., if the signal 18 has increased substantially above the maximum expected positive value, or substantially below the minimum expected negative value). Similarly, the fault detector 36 may be configured such that the comparator 70 determines if the signal 18 is below the lowest level threshold, such as nominally zero volts, indicative of a short-circuit-to-ground fault or a negative voltage for negative output power supplies 12. Upon detecting that the received 18 has exceeded the predetermined threshold(s), the fault detector 36 transmits a fault signal to each of the isolators 30 indicating the isolation of the faulty signal 18 from the output terminals 22 (step 58). Alternatively, if the fault detector 36 determines that the received signal has not exceeded the predetermined threshold(s), the device 10 generates the first and second current-share output signals (step 60). In one embodiment, the current share output signals are generated by splitting the received power-supply current-share output signal 18. Having generated the first and second current-share output signals, the device transmits the generated signals from the first and second output terminals 22 (step 62).

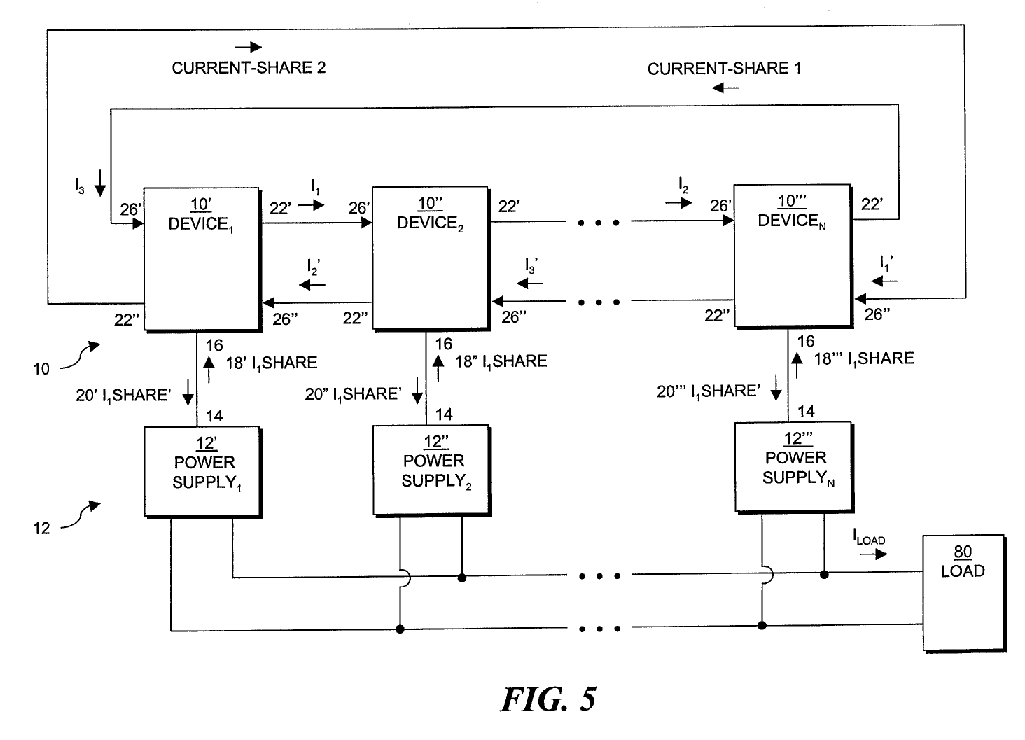

Referring now to FIG. 5, in one embodiment a number of power supplies 12′, 12″ . . . 12′″ (generally 12) operate in combination to provide current to an electrical load 80. To provide the load current (I_{LOAD}) in a coordinated manner, such as providing an overall regulated load current, the power supplies 12 each provide a power-supply current-share output signal 18′, 18″. The power-supply current-share output signal 18 of one of the number of power supplies 12 is representative of the amount of current being supplied by that power supply 12 to the electrical load 80. A respective one of a number of devices, 10′, 10″ . . . 10′″ (generally 10), one device 10 being in electrical communication with one of the number of power supplies 12, receives the power-supply current-share output signal 18 from the power supply 12. The device 10 operates to separate the received power-supply current-share output signal 18 into two, substantially equivalent current-share output signals. The device 10 first splits the power-supply current-share output signal 18 into two substantially equivalent signals representative of the power-supply current-share output signal 18, then electrically isolates, using the isolators 30, each of the split-versions of the signal 18 from the output terminals 22 before transmitting the current share output signals. In some embodiments, the isolators 30 isolate the power-supply terminal 16 from the respective output terminals 22 responsive to a control (fault) signal. In some embodiments, electrical isolation includes buffering. In other embodiments, electrical isolation includes open-circuiting or incorporating a high-impedance.

In one embodiment, the device 10 also receives multiple current-share input signals, combines the received signals, and transmits the power-supply current-share input signal 20, relating to the received current-share input signals, to the power supply 12. The power supply 12, receiving the power-supply current-share input signal 20, adjusts the amount of current it is supplying to the electrical load 80 responsive to the power-supply current-share input signal 20. For example, in one embodiment, an increase in value of the power-supply current-share input signal 20 indicates that the power supply 12 should increase its output current contribution to the electrical load. The power supply 12 responsive to the increased power-supply current-share input signal 30 increases its output current contribution accordingly. In turn, the power-supply current-share output signal 18, representative of the current being supplied to the electrical load 80, increases by a representative amount. In other embodiments, the power supply 12 may respond inversely to the power-supply current-share input signal 30 (e.g., provide increased current to the electrical load 80 responsive to a reduced value power-supply current-share input signal 20).

In an illustrative example of one embodiment, referring again to FIG. 5, in which there are three power supplies 12 (i.e., substituting DEVICE_{N}10′″ with DEVICE₃10′″ and substituting POWER SUPPLY_{N}10′″ with POWER SUPPLY₃10′″). The three power supplies: POWER SUPPLY₁ 12′, POWER SUPPLY₂ 12″, POWER SUPPLY₃ 12′″ (generally 12), are in electrical communication with respective devices: DEVICE₁ 10′, DEVICE₂ 10″, DEVICE₃ 10′″ (generally 10), the three power supplies 12 providing a regulated output current (I_{LOAD}) to the electrical load 80. A representative embodiment of each of the devices 10, is shown in FIG. 1. The devices 10 may be configured as shown, where, for example, DEVICE₂ 10″ provides the first current-share output signal (I₂) to DEVICE₃ 10′″ and receives from DEVICE₃ 10′″ the second current-share signal (I₃′). Similarly, DEVICE₂ 10″ provides the second current-share output signal (I₂′) to DEVICE₁ 10′ and receives from DEVICE₁ 10′ the first current-share signal (I₁). DEVICE₃ 10′″ provides the first current-share output signal (shown as I₃) to DEVICE₁ 10′ and receives from DEVICE₁ 10′ the second current-share signal (I₁′).

Referring to Table 1, the current relationships are shown for an embodiment where the power supply 12 adjusts its current output responsive to the greater of the two current-share input signals received at the associated device 10.

TABLE 1
Current Relationships

| Power-Supply Current- | |
|---|---|
| Share Input Signal | Current-Share Input Signal |
| I₁ SHARE 20′ = | I₃ or I₂′; whichever signal is largest |
| I₂ SHARE 20″ = | I₁ or I₃′; whichever signal is largest |
| I₃ SHARE 20′′′ = | I₂ or I₁′; whichever signal is largest |

If a fault in the current-share signals associated with POWER SUPPLY₂ 12″ such that I₂ and I₂′ are 0 volts, then I_{1 SHARE}=I₃ and I_{3 SHARE}=I₁. Thus, faulty POWER SUPPLY₂ 12″ may be turned-off or isolated from the load 44, while the remaining power supplies (POWER SUPPLY₁ 12′ and POWER SUPPLY₃ 12′″) continue to current share, supplying current to the load 80. Similar results are obtained if this example is repeated for a fault occurring at either of the other power supplies (POWER SUPPLY₁ 12′ and POWER SUPPLY₃ 12′″), where the faulted power supply 12 is turned off or isolated from the load 44, while the remaining power supplies 12 continue to current share, supplying current to the load 44.

Referring now to Table 2A, the test results are provided for an example using three parallel power supply configuration shown in FIG. 5, where each of the power supplies includes a standard 450 Watt power supply module, manufactured by Delta Electronics of Lowell, Mass., having 12 volt/25 amp outputs. In this example, POWER SUPPLY₂ 12″ functioned as master, transmitting current-share output signals approximately 0.6 volts greater than the current-share output signals of either of the other power supplies 12. The respective power-supply current-share input signal 30 are shown for increasing values of I_{LOAD}.

TABLE 2A
Fault-Tolerant 12 Volt Power Supply Test Results

| Test | I_{LOAD} | Current- | Current- | Current- | |
|---|---|---|---|---|---|
| Mode | (Amps) | I_{1 SHARE} | I_{2 SHARE} | I_{3 SHARE} | Comments |
| Normal | 0 | .488 | .434 | .422 | POWER SUPPLY₂ 12″ |
| | | | | | is system master |
| Normal | 5 | .522 | 1.082 | .508 | ↓ |
| Normal | 10 | .795 | 1.379 | .792 | ↓ |
| Normal | 20 | 1.819 | 2.424 | 1.818 | ↓ |
| Normal | 30 | 2.871 | 3.490 | 2.871 | ↓ |
| Normal | 40 | 3.957 | 4.588 | 3.958 | ↓ |
| Normal | 50 | 5.087 | 5.730 | 5.088 | ↓ |
| Normal | 60 | 6.198 | 6.855 | 6.206 | ↓ |
| Normal | 70 | 7.316 | 7.964 | 7.319 | ↓ |

Table 2B illustrates the power-supply current share input signal levels during faulted mode operation of each of the three power supplies 12. In the illustrative example, the a load current remains at nominally 40 Amps without disturbance during a failure of one of the respective power supplies 12 as indicated in the first column.

TABLE 2B
Fault-Tolerant 12 Volt Power Supply Test Results

| Test | I_{LOAD} | Current- | Current- | Current- | |
|---|---|---|---|---|---|
| Mode | (Amps) | I_{1 SHARE} | I_{2 SHARE} | I _{3 SHARE} | Comments |
| I_{1 SHARE} | 40 | 0 | 6.170 | 5.411 | POWER SUPPLY₂ 12″ |
| Faulted | | | | | is system master |
| I_{2 SHARE} | 40 | 6.74 | 0 | 5.945 | POWER SUPPLY₁ 12′ is |
| Faulted | | | | | system master |
| I_{3 SHARE} | 40 | 5.901 | 60641 | 0 | POWER SUPPLY₂ 12″ |
| Faulted | | | | | is system master |

Having shown the preferred embodiments, one skilled in the art will realize that many variations are possible within the scope and spirit of the claimed invention. It is therefor the intention to limit the invention only by the scope of the claims.

What is claimed is:

1. A fault-tolerant current sensing apparatus allowing a power supply system comprising a plurality of power supplies, each power supply having a current-share terminal, to tolerate a failure at the current-share terminal of one of the plurality of power supplies, the apparatus comprising:
a power-supply terminal in electrical communication with a current-share terminal of a power supply;
a first output terminal transmitting a first current-share output signal;
a second output terminal transmitting a second current-share output signal;
a first isolator in electrical communication with the first output terminal and the power supply terminal;
a second isolator in electrical communication with the second output terminal and the power supply terminal;
a first input terminal in electrical communication with the power-supply terminal and receiving a first current-share input signal; and
a second input terminal in electrical communication with the power-supply terminal and receiving a second current share input signal.

2. The apparatus of claim 1 wherein the first isolator comprises a current-sourcing amplifier.

3. The apparatus of claim 2 wherein the current-sourcing amplifier comprises a unity gain amplifier.

4. The apparatus of claim 1 wherein the first isolator comprises an operational amplifier.

5. The apparatus of claim 4 wherein the first isolator further comprises a output diode.

6. The apparatus of claim 1 wherein the first isolator comprises a single-stage transistor amplifier.

7. The apparatus of claim 6 wherein the single-stage transistor amplifier comprises an emitter-follower amplifier.

8. The apparatus of claim 1 further comprising a fault detector in electrical communication with the power-supply terminal.

9. The apparatus of claim 8 further comprising:
(a) a first switch in electrical communication between the power-supply terminal and the first output terminal, the first switch operating responsive to a signal received from the fault detector; and
(b) a second switch in electrical communication between the power supply terminal and the second output terminal, the second switch operating responsive to the signal received from the fault detector.

10. The apparatus of claim 9 wherein the first switch comprises an electronic switch.

11. The apparatus of claim 10 wherein the electronic switch comprises a transistor.

12. The apparatus of claim 11 wherein the transistor comprises a field-effect transistor.

13. The apparatus of claim 8 wherein the fault detector comprises:
a monitor receiving a power-supply current-share output signal; and
a comparator determining a difference between the received power-supply current-share output signal and a predetermined signal threshold.

14. The apparatus of claim 13 further comprising a signal-reference source in electrical communication with the comparator providing a signal level corresponding to the predetermined signal threshold.

15. In a current-sharing power supply system comprising a plurality of power supplies, each power supply (i) having an output load terminal connected in parallel and supplying an output current to a load, (ii) having a current-share terminal receiving a power-supply current-share input signal, (iii) being capable of controlling its respective output current responsive to the power-supply current-share input signal, and (iv) transmitting a power-supply current-share output signal, a method for tolerating a failure affecting the power-supply current-share output signal comprising the steps of:
(a) receiving a first current-share input signal;
(b) receiving a second current-share input signal;
(c) transmitting a power-supply current-share input signal to a power supply;
(d) receiving a power-supply current-share output signal from the power supply;
(e) generating, from the power-supply current-share output signal, a first current-share output signal;
(f) generating, from the power-supply current-share output signal, a second current-share output signal;
(g) transmitting the first current-share output signal; and
(h) transmitting the second current-share output signal.

16. The method of claim 15 further comprising the step of generating the power-supply current-share input signal by combining the first current-share input signal and the second current-share input signal.

17. The method of claim 15 further comprising the step of electrically isolating the power-supply current-share input signal from the first current-share output signal and the second current-share output signal.

18. The method of claim 17 wherein the step of isolating the power-supply current-share input signal from the first current-share output signal and the second current-share output signal comprises conditioning each of the first and second current-share output signals using an electrical amplifier.

19. The method of claim 15 further comprising the step of detecting a fault with the power-supply current-share output signal.

20. The method of claim 19 wherein the step of detecting a fault further comprises:
(a) monitoring the power-supply current-share output signal; and
(b) comparing the monitored signal to a predetermined signal threshold.

21. The method of claim 20 wherein the fault is detected when the monitored signal exceeds a predetermined signal threshold.

22. The method of claim 19 further comprising the step of isolating the first and second current-share output signals from the power-supply current-share output signal responsive to detecting the fault.

23. The method of claim 22 wherein the step of isolating the first and second current-share output signals from the power-supply current-share output signal comprises controlling a switch responsive to detecting the fault.

24. The method of claim 22 wherein the step of isolating the first and second current-share output signals from the power-supply current-share output signal comprises driving the power-supply current-share output signal to a fault signal level.

25. The method of claim 22 wherein the step of isolating at least one of the first and second current-share output signals from the power-supply current-share output signal comprises driving the power-supply current-share output signal to electrical ground.

26. A fault-tolerant current-sharing power supply system comprising:
a plurality of power supplies, each power supply having a load terminal in electrical communication with a load providing a proportional output current to the load and a current-share terminal receiving a power-supply current-share input signal, each power supply capable of modifying its output current responsive to the received power-supply current-share input signal;
a plurality of fault-tolerant current-sharing devices, each having:
a power-supply terminal in electrical communication with the current-share terminal of a respective one of the plurality of power supplies;
a first and a second input terminal, each in electrical communication with the power supply terminal;
a first and a second output terminal in electrical communication with a respective one of the first and second input terminal of another of the plurality of current-sharing devices; and
a first and a second isolator, each in electrical communication with the power-supply terminal and a respective one of the first and second output terminal.

27. The system of claim 26 wherein the power-supply terminal of the fault-tolerant current-sharing device is in electrical communication with the current-share terminal of a respective one of the power supplies via a single-wire, unidirectional bus.

28. The system of claim 26 further comprising a fault detector identifying a faulty power-supply current-share output signal received from the power supply.

29. The system of claim 28 wherein the fault detector comprises a comparator detecting a fault responsive to the power-supply current-share output signal exceeding a predetermined threshold.

30. An apparatus for fault-tolerant current-sharing in a power supply system comprising a plurality of power supplies, each power supply (i) having an output load terminal connected in parallel and supplying an output current to a load, (ii) having a current-share terminal receiving a power-supply current-share input signal, (iii) being capable of controlling its respective output current responsive to the power-supply current-share input signal, and (iv) transmitting a power-supply current-share output signal comprising:
means for receiving a first current-share input signal;
means for receiving a second current-share input signal;
means for transmitting a power-s upply current-share input signal to a power supply;
means for receiving a power-supply current-share output signal from the power supply;
means for generating, from the power-supply current-share output signal, a first current-share output signal;
means for generating, from the power-supply current-share output signal, a second current-share output signal;
means for transmitting a first current-share output signal; and
means for transmitting a second current-share output signal.

31. The apparatus of claim 30 further comprising a means for isolating the first current-share output signal from the power-supply current-share output signal.

32. The apparatus of claim 31 wherein the isolation means comprises a switching means for electrically isolating the first current-share output signal from the power-supply current-share output signal.

33. The apparatus of claim 31 further comprising a means for detecting a fault in the power-supply current-share output signal.

34. The apparatus of claim 33 wherein the fault-detection means comprises a means for comparing the power-supply current-share output signal to a predetermined threshold.

35. A fault-tolerant current-sensing apparatus allowing a power supply system comprising a plurality of power supplies, each power supply having a current-share terminal, to tolerate a failure at the current-share terminal of a power supply, the apparatus comprising:
a power-supply terminal in electrical communication with a current-share terminal of a power supply;
a first field-effect transistor switch in communication with the power supply terminal;
a first amplifier having an input in electrical communication with the field-effect transistor switch and an output, the first amplifier transmitting a first current-share output signal;
a first output terminal in electrical communication with the first amplifier output;
a first input terminal in electrical communication with the power-supply terminal and receiving a first current-share input signal;
a second field-effect transistor switch in communication with the power supply terminal;
a second amplifier having an input in electrical communication with the field-effect transistor switch and an output, the second amplifier transmitting a second current-share output signal;
a second output terminal in electrical communication with the second amplifier output;
a second input terminal in electrical communication with the power-supply terminal and receiving a second current share input signal; and
a fault detector in communication with the power-supply terminal, detecting a faulty power-supply current-share output signal.
